(19) United States
(12) Patent Application Publication
(10) Pub. No.: US 2024/0022616 A1
(43) Pub. Date: Jan. 18, 2024

(54) WEBRTC SIGNALING AND DATA CHANNEL IN FIFTH GENERATION (5G) MEDIA STREAMING

(71) Applicant: Intel Corporation, Santa Clara, CA (US)

(72) Inventor: Shuai Zhao, Rancho Cordova, CA (US)

(21) Appl. No.: 18/366,380

(22) Filed: Aug. 7, 2023

Related U.S. Application Data
(60) Provisional application No. 63/397,281, filed on Aug. 11, 2022.

(51) Int. Cl. H04L 65/1108; H04L 65/1069; H04L 61/2503

(52) U.S. Cl. CPC H04L 65/1108; H04L 65/1069; H04L 61/2503

(57) ABSTRACT

Various embodiments herein provide techniques related to signaling or data channel management or functions in media streaming. In embodiments, a WebRTC signaling server may be configured to identify, from a 5G media services (5GMS) application function (AF) via a communication interface, one or more received control plane parameters that are associated with a user equipment (UE) of a wireless cellular network; and establish a WebRTC control plane for the UE based on the one or more control plane parameters. Other embodiments may be described and/or claimed.

### CROSS REFERENCE TO RELATED APPLICATION

The present application claims priority to U.S. Provisional Patent Application No. 63/397,281, which was filed Aug. 11, 2022; the disclosure of which is hereby incorporated by reference.

### FIELD

Various embodiments generally may relate to the field of wireless communications. For example, some embodiments may relate to signaling or data channel management or functions in media streaming.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example fifth generation (5G) media streaming general architecture, in accordance with various embodiments.

FIG. 2 illustrates an example of 5G support for over-the-top (OTT) WebRTC, in accordance with various embodiments.

FIG. 3 illustrates an example of mobile network operator (MNO)-provided trusted WebRTC functions, in accordance with various embodiments.

FIG. 4 illustrates an example of MNO-facilitated WebRTC services, in accordance with various embodiments.

FIG. 5 illustrates an example of inter-operable WebRTC services, in accordance with various embodiments.

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 illustrates an alternative example of a wireless network, in accordance with various embodiments.

FIG. 10 depicts an example process related to signaling or data channel management or functions in media streaming, in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

The traditional third generation partnership project (3GPP) multimedia telephony service for internet protocol multimedia subsystem (IMS), referred to as “MTSI,” services, real-time transport of media over 5G systems may be desirable in new areas, especially for the transport of immersive media for extended reality (XR) conferencing services, as often illustrated in the use cases regarding Metaverse, and the transport of media between third party applications in the device and network. To support these new features and applications, it may be desirable to develop WebRTC-based components that are integrated into, and optimized for, the 5G system. WebRTC may be considered to be a real time communication protocol as standardized, for example, by webrtc.org.

Compared with the legacy IMS-based and hypertext transfer protocol (HTTP)-based conversational streaming methods, WebRTC may present benefits for streaming immersive media data over 5G network. For example, WebRTC 1) may use User Datagram Protocol (UDP) for faster packet delivery without the overhead from transmission control protocol (TCP) used by HTTP(s) 2) may use real-time transport protocol (RTP) to transmit video over the Internet and other internet protocol (IP) networks 3) may provide lower latency due to the protocol stack being based off or related to RTP/UDP/IP.

WebRTC was initially designed for peer-2-peer communication and typically can establish direct connections among individual UEs (user equipment). In order to make direct communication between any devices behind network middlebox such as NATs, the WebRTC leverages STUN, TURN, and ICE protocols for routing UDP traffic.

In legacy networks or specifications, the support of WebRTC in 5G may be limited and not fully designed/deployed because of a lack of architecture considerations due to 1) complex WebRTC collaboration modes among MNO (mobile network operator) or PLMN 2) lack of application programming interface (API) support for multiple network entities.

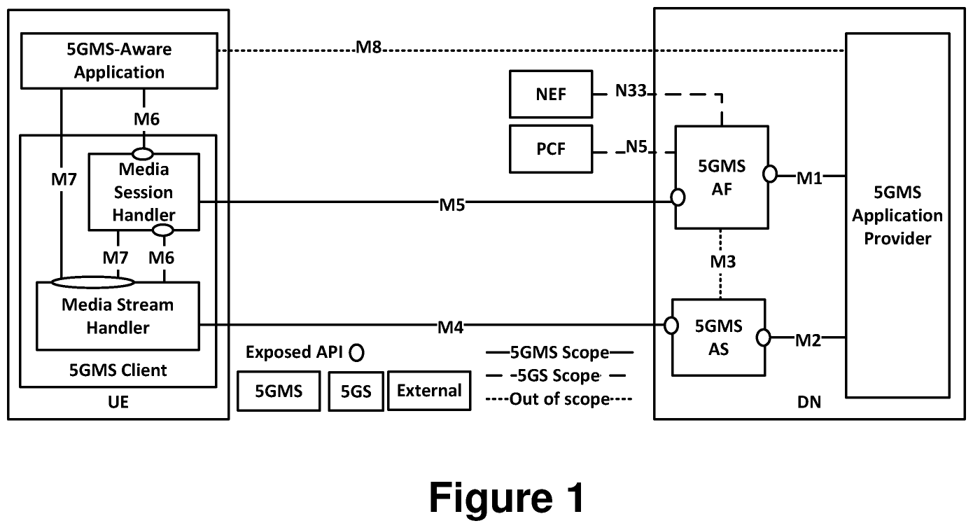

The 5GMS (5G media streaming) architecture may support media streaming services and provide UE functions and APIs. However, in order to support WebRTC under various operation modes, an extra network interface may be needed. A example overall 5G Media Streaming Architecture is shown in FIG. 1a.

Various embodiments herein provide new interfaces to support WebRTC signaling control plane establishment in 5GMS (5G media streaming) architecture under various WebRTC deployment scenarios. Embodiments may enable supporting WebRTC control plane using existing 5GMS architecture with adding new interface support.

Embodiments herein may relate to or provide a system and mechanism for supporting the WebRTC control plane using existing 5GMS architecture with adding new interface support.

Note: that the names of the described interfaces are presented as examples; the interfaces can be named differently in other embodiments.

WebRTC communication may use two major components: 1) a signaling/control plane and 2) a transport/data plane. The basic design principle of WebRTC is to enable Peer-to-Peer communication without the intervention of the media-aware middlebox. The general guideline is that participants should be minimum depending on various considerations such as UE capability, media codecs, etc. However, scalability can be achieved when media-aware middleboxes are in place such as an multipoint control unit (MCU)/selective forwarding unit (SFU).

The 5GMS defined media-streaming architecture for both uplink and downlink streaming. A 5GMS-aware application is enabled to utilize the M5 interface for media session handling and the M4 interface for streaming transport handling. This contribution is related to identifying the possible usage of 5GMS for immersive RTC signaling and streaming based on 5GMS existing interfaces.

In some embodiments, 1) 5GMS AF may be used as a WebRTC signaling control component; and/or 2) 5GMS AS may be used as a media server for WebRTC uplink and downlink streaming.

Interfaces for WebRTC control plane establishment may include one or both of:
1) RTC-1: an interface between an application function (AF) and a WebRTC signaling server.
2) RTC-2: an interface between the WebRTC signaling server and the STUN/TURN server.

As used herein NAT may refer to “network address translation.” STUN may refer to ‘Session Traversal Utilities for NAT.” TURN may refer to “Traversal Using Relays around NAT.”

Note: Embodiments herein may be described based on the assumption that the STUN/TURN server is a single entity. However, embodiments may also be used with implementations in which the STUN and TURN servers are separate entities.

WebRTC Coloration Mode/Scenarios

The following are four example WebRTC Collaboration scenarios. In this disclosure, we dissect each collaboration mode and introduce the basic workflow using 5GMS for WebRTC data and control plane with proposed RTC-1 and RTC-2 interfaces.

2.1 5G Support for OTT WebRTC.

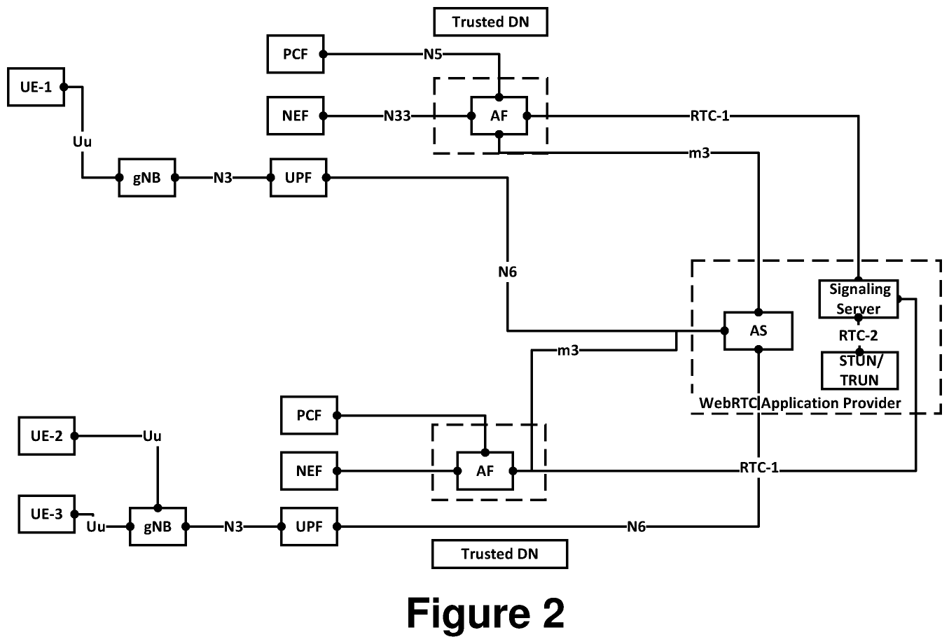

Referring to FIG. 2, both WebRTC signaling and STUN/TURN service are offered by the WebRTC application provider. M5 interface in 5GMS may be used to establish a WebRTC control plane through AF using RTC-1 interface with a Signaling server. RTC-2 is used between the signaling server and STUN/TURN for UE NAT traversal.

For example, in FIG. 2, UE-1 registers with PLMN-1. UE-2 and UE-3 registers with PLMN-2. UEs use their respective 5GMS AF to establish WebRTC signaling and control plane establishment with the WebRTC signaling server through the RTC-1 interface.

After the control plane has been established, UE may request a PDU session through 5GMS AF with PCF using the N5 interface.

Assuming the PDU session is created successfully and 5QI has been assigned to UE, gNB and UPF, the data plane may go through m4 interface, which is the PDU session between UE and UPF.

UE-1 may start streaming its WebRTC session using the m4u interface. Media data may be stored and hosted in 5GMS AS. UE-2 and UE-3 may use the m4d interface to download UE-1's WebRTC media data through AS.

2.2 MNO-Provided Trusted WebRTC Functions

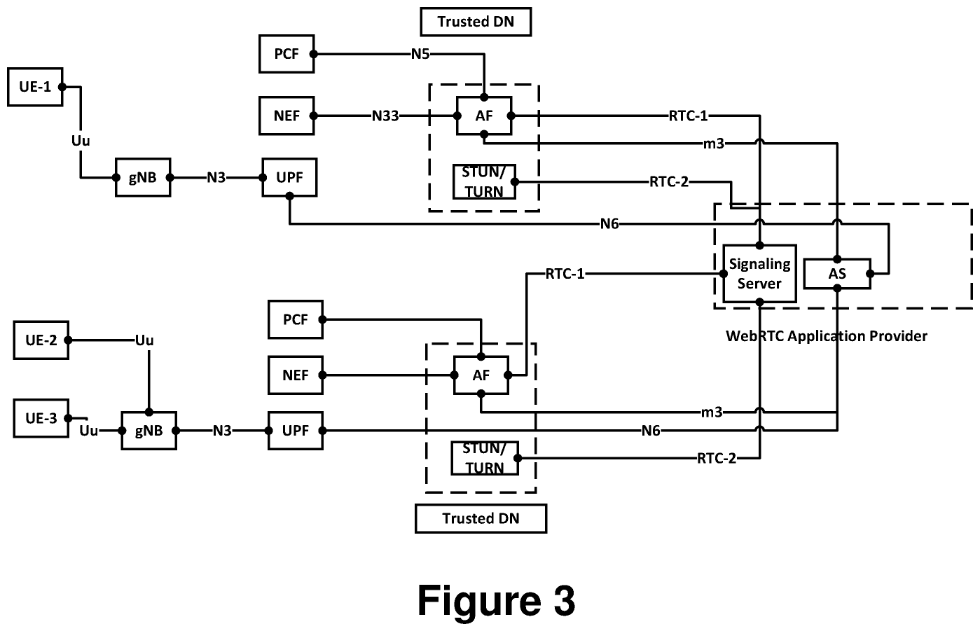

Referring to FIG. 3, WebRTC signaling service is offered by the WebRTC application provider. STUN/TURN service is offered through individual PLMN. The WebRTC signaling process is similar to clause 2.1, above.

2.3 MNO-Facilitated WebRTC Services

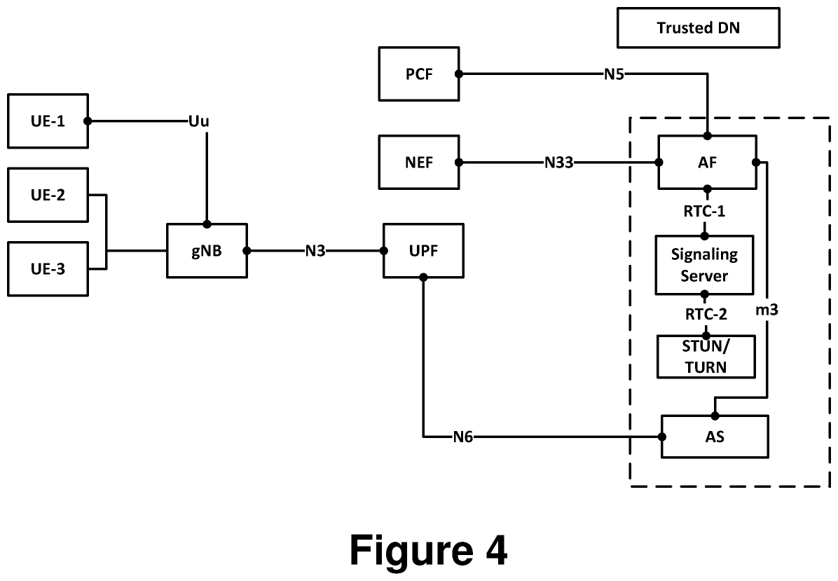

Referring to FIG. 4, both WebRTC signaling, and STUN/TURN service are offered by the PLMN. In this case, all UEs are registered to the same PLMN. The WebRTC signaling process is similar to clause 2.1, above.

2.4. Inter-Operable WebRTC Services

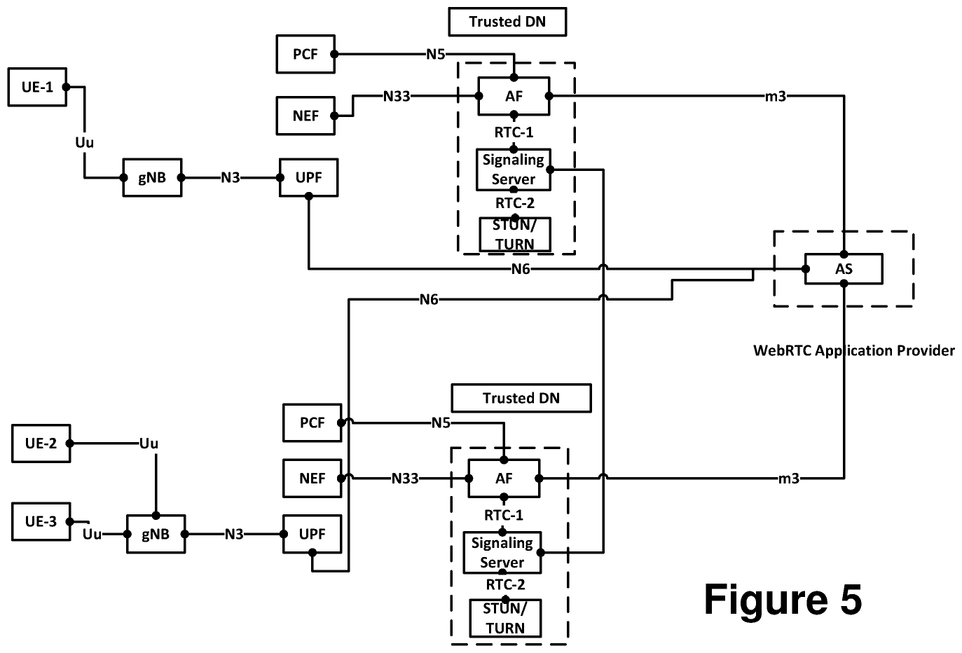

Referring to FIG. 5, both WebRTC signaling, and STUN/TURN service are offered by the PLMN.

In this case, UE-1 is registered with PLMN-1. UE-2 and UE-3 are registered with PLMN. The WebRTC signaling process is similar to clause 2.1, above. In order to support inter-operability among different PLMN, a 5GMS AS entity may be deployed in a WebRTC application provider in order for UEs from different PLMN to upload and download their media traffic.

### Systems and Implementations

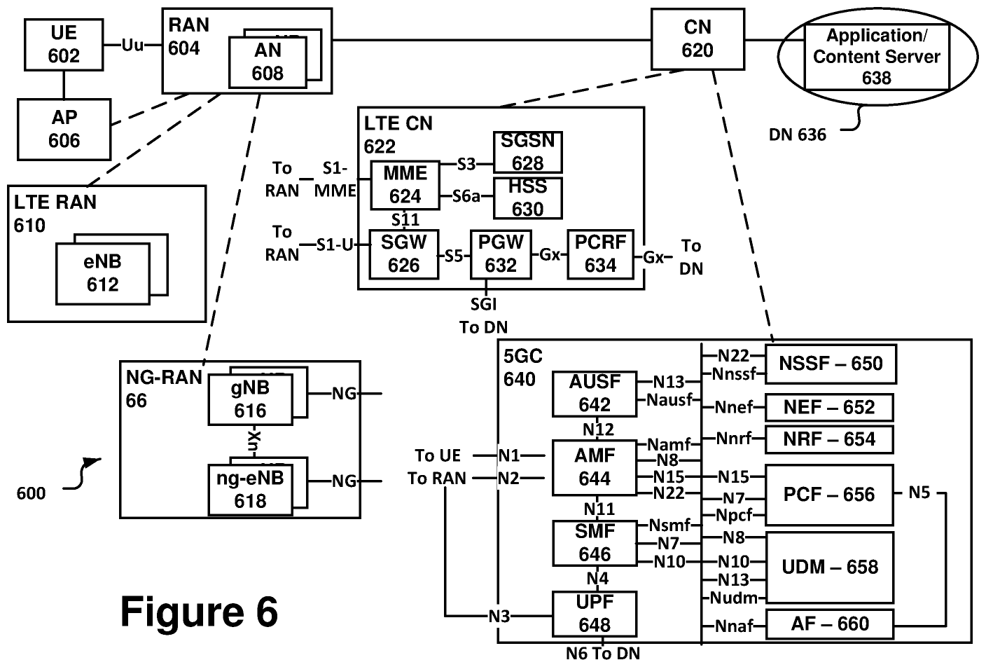

FIGS. 6-9 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNB s, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNB s, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re)selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

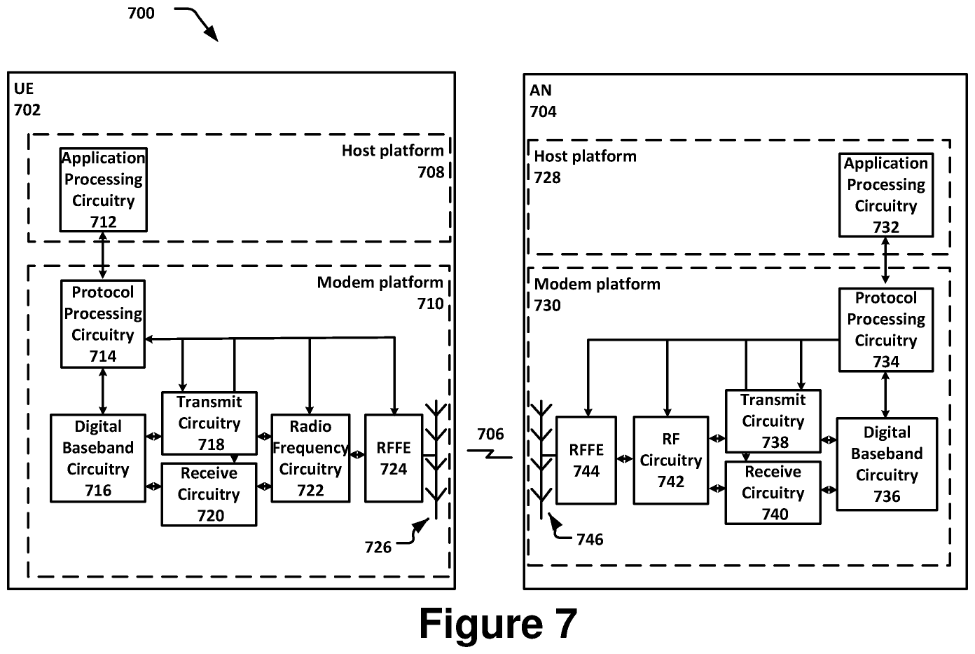

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mmWave or sub-6 GHz frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

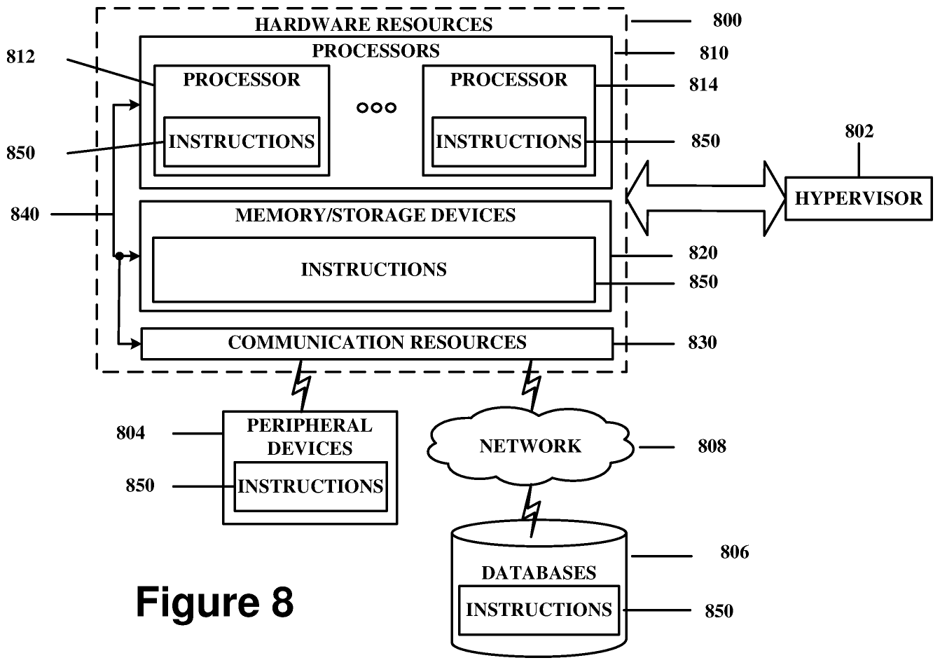

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc., cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

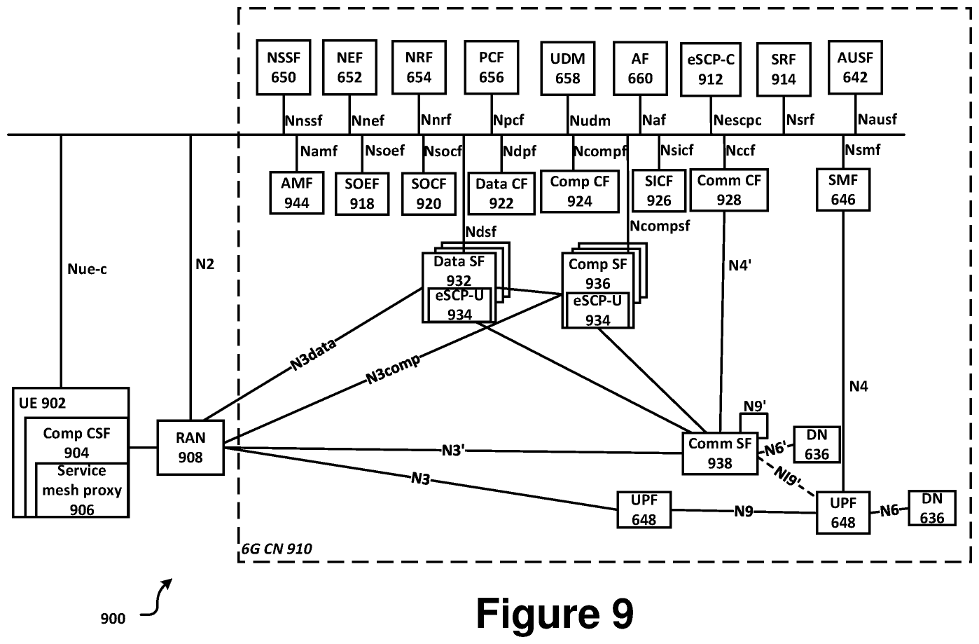

FIG. 9 illustrates a network 900 in accordance with various embodiments. The network 900 may operate in a matter consistent with 3GPP technical specifications or technical reports for 6G systems. In some embodiments, the network 900 may operate concurrently with network 600. For example, in some embodiments, the network 900 may share one or more frequency or bandwidth resources with network 600. As one specific example, a UE (e.g., UE 902) may be configured to operate in both network 900 and network 600. Such configuration may be based on a UE including circuitry configured for communication with frequency and bandwidth resources of both networks 600 and 900. In general, several elements of network 900 may share one or more characteristics with elements of network 600. For the sake of brevity and clarity, such elements may not be repeated in the description of network 900.

The network 900 may include a UE 902, which may include any mobile or non-mobile computing device designed to communicate with a RAN 908 via an over-the-air connection. The UE 902 may be similar to, for example, UE 602. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 9, in some embodiments the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 9, the UE 902 may be communicatively coupled with an AP such as AP 606 as described with respect to FIG. 6. Additionally, although not specifically shown in FIG. 9, in some embodiments the RAN 908 may include one or more ANss such as AN 608 as described with respect to FIG. 6. The RAN 908 and/or the AN of the RAN 908 may be referred to as a base station (BS), a RAN node, or using some other term or name.

The UE 902 and the RAN 908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 908 may allow for communication between the UE 902 and a 6G core network (CN) 910. Specifically, the RAN 908 may facilitate the transmission and reception of data between the UE 902 and the 6G CN 910. The 6G CN 910 may include various functions such as NSSF 650, NEF 652, NRF 654, PCF 656, UDM 658, AF 660, SMF 646, and AUSF 642. The 6G CN 910 may additional include UPF 648 and DN 636 as shown in FIG. 9.

Additionally, the RAN 908 may include various additional functions that are in addition to, or alternative to, functions of a legacy cellular network such as a 4G or 5G network. Two such functions may include a Compute Control Function (Comp CF) 924 and a Compute Service Function (Comp SF) 936. The Comp CF 924 and the Comp SF 936 may be parts or functions of the Computing Service Plane. Comp CF 924 may be a control plane function that provides functionalities such as management of the Comp SF 936, computing task context generation and management (e.g., create, read, modify, delete), interaction with the underlaying computing infrastructure for computing resource management, etc. Comp SF 936 may be a user plane function that serves as the gateway to interface computing service users (such as UE 902) and computing nodes behind a Comp SF instance. Some functionalities of the Comp SF 936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 936 instance may serve as the user plane gateway for a cluster of computing nodes. A Comp CF 924 instance may control one or more Comp SF 936 instances.

Two other such functions may include a Communication Control Function (Comm CF) 928 and a Communication Service Function (Comm SF) 938, which may be parts of the Communication Service Plane. The Comm CF 928 may be the control plane function for managing the Comm SF 938, communication sessions creation/configuration/releasing, and managing communication session context. The Comm SF 938 may be a user plane function for data transport. Comm CF 928 and Comm SF 938 may be considered as upgrades of SMF 646 and UPF 648, which were described with respect to a 5G system in FIG. 6. The upgrades provided by the Comm CF 928 and the Comm SF 938 may enable service-aware transport. For legacy (e.g., 4G or 5G) data transport, SMF 646 and UPF 648 may still be used.

Two other such functions may include a Data Control Function (Data CF) 922 and Data Service Function (Data SF) 932 may be parts of the Data Service Plane. Data CF 922 may be a control plane function and provides functionalities such as Data SF 932 management, Data service creation/configuration/releasing, Data service context management, etc. Data SF 932 may be a user plane function and serve as the gateway between data service users (such as UE 902 and the various functions of the 6G CN 910) and data service endpoints behind the gateway. Specific functionalities may include: parse data service user data and forward to corresponding data service endpoints, generate charging data, report data service status.

Another such function may be the Service Orchestration and Chaining Function (SOCF) 920, which may discover, orchestrate and chain up communication/computing/data services provided by functions in the network. Upon receiving service requests from users, SOCF 920 may interact with one or more of Comp CF 924, Comm CF 928, and Data CF 922 to identify Comp SF 936, Comm SF 938, and Data SF 932 instances, configure service resources, and generate the service chain, which could contain multiple Comp SF 936, Comm SF 938, and Data SF 932 instances and their associated computing endpoints. Workload processing and data movement may then be conducted within the generated service chain. The SOCF 920 may also responsible for maintaining, updating, and releasing a created service chain.

Another such function may be the service registration function (SRF) 914, which may act as a registry for system services provided in the user plane such as services provided by service endpoints behind Comp SF 936 and Data SF 932 gateways and services provided by the UE 902. The SRF 914 may be considered a counterpart of NRF 654, which may act as the registry for network functions.

Other such functions may include an evolved service communication proxy (eSCP) and service infrastructure control function (SICF) 926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 912 and eSCP-U 934, for control plane service communication proxy and user plane service communication proxy, respectively. The SICF 926 may control and configure eCSP instances in terms of service traffic routing policies, access rules, load balancing configurations, performance monitoring, etc.

Another such function is the AMF 944. The AMF 944 may be similar to 644, but with additional functionality. Specifically, the AMF 944 may include potential functional repartition, such as move the message forwarding functionality from the AMF 944 to the RAN 908.

Another such function is the service orchestration exposure function (SOEF) 918. The SOEF may be configured to expose service orchestration and chaining services to external users such as applications.

The UE 902 may include an additional function that is referred to as a computing client service function (comp CSF) 904. The comp CSF 904 may have both the control plane functionalities and user plane functionalities, and may interact with corresponding network side functions such as SOCF 920, Comp CF 924, Comp SF 936, Data CF 922, and/or Data SF 932 for service discovery, request/response, compute task workload exchange, etc. The Comp CSF 904 may also work with network side functions to decide on whether a computing task should be run on the UE 902, the RAN 908, and/or an element of the 6G CN 910.

The UE 902 and/or the Comp CSF 904 may include a service mesh proxy 906. The service mesh proxy 906 may act as a proxy for service-to-service communication in the user plane. Capabilities of the service mesh proxy 906 may include one or more of addressing, security, load balancing, etc.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

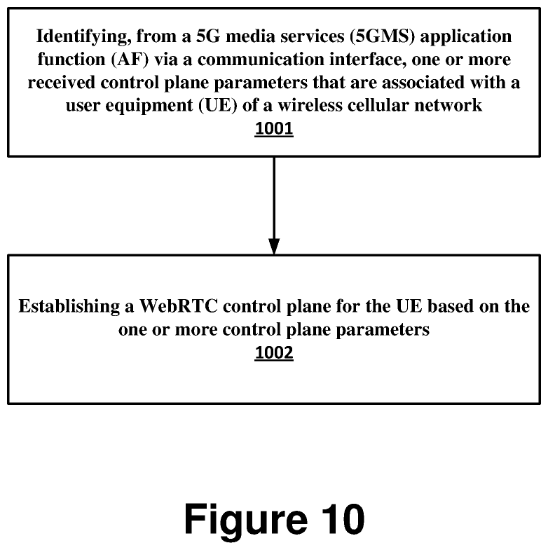

In embodiments, one such process may be depicted in FIG. 10. Specifically, FIG. 10 may include or relate to a method to be performed by a WebRTC signaling server, one or more electronic devices that include and/or implement a WebRTC signaling server, and/or one or more components thereof. The process may include identifying, at 1001 from a 5G media services (5GMS) application function (AF) via a communication interface, one or more received control plane parameters that are associated with a user equipment (UE) of a wireless cellular network; and establishing, at 1002, a WebRTC control plane for the UE based on the one or more control plane parameters.

### EXAMPLES

Example 1 may include a method for establishing a WebRTC signalling channel in 5G media streaming (5GMS)

Example 2 may include the method of example 1 or some other example herein, whereby a pre-configured m5 interface is used between a UE and 5GMS AF (application server)

Example 3 may include the method of example 1 or some other example herein, whereby a WebRTC signaling server may be deployed.

Example 4 may include the method of example 1 or some other example herein, whereby a WebRTC STUN or TURN server may be deployed.

Example 5 may include the method of example 2 or some other example herein, whereby an interface RTC-1 is configured between AF and WebRTC signaling server. The UE's WebRTC control plane parameter is carried through m5 interface to AF which is then passed to the WebRTC signaling server.

Example 6 may include the method of example 3 or some other example herein, whereby a WebRTC signaling server may be deployed in the same MNO or different MNO compared with UE's registration.

Example 7 may include the method of example 4 or some other example herein, whereby a STUN/TURN server may be deployed in the same MNO or different MNO compared with UE's registration.

Example 8 may include the method of example 5 or some other example herein, whereby an interface RTC-2 may be configured for networking addressing discovery.

Example 9 may include a method of a WebRTC signaling server, the method comprising: receiving, from a 5G media services (5GMS) application function (AF) via a communication interface, one or more control plane parameters associated with a UE of a wireless cellular network; and establishing a WebRTC control plane for the UE based on the one or more control plane parameters.

Example 10 may include the method of example 9 or some other example herein, wherein the communication interface is a first communication interface, and wherein the method further comprises communicating UE NAT information with a STUN/TURN server for WebRTC service.

Example 11 may include the method of example 9-10 or some other example herein, wherein the WebRTC signaling server is deployed in a same MNO or a different MNO from the UE.

Example 12 relates to a method to be performed by a WebRTC signaling server, one or more elements of a WebRTC signaling server, and/or one or more electronic devices that include and/or implement a WebRTC signaling server, wherein the method comprises: identifying, from a 5G media services (5GMS) application function (AF) via a communication interface, one or more received control plane parameters that are associated with a user equipment (UE) of a wireless cellular network; and establishing a WebRTC control plane for the UE based on the one or more control plane parameters.

Example 13 includes the method of example 12, and/or some other example herein, wherein the communication interface is a first communication interface, and wherein the instructions are further to cause the WebRTC signaling server to send or receive UE network address translation (NAT)-related information with a second WebRTC server via a second communication interface.

Example 14 includes the method of example 13, and/or some other example herein, wherein the second communication interface is a RTC-2 interface.

Example 15 includes the method of example 13, and/or some other example herein, wherein the second WebRTC server is a Session Traversal Utilities for NAT (STUN) server.

Example 16 includes the method of example 13, and/or some other example herein, wherein the second WebRTC server is a Traversal Using Relays around NAT (TURN) server.

Example 17 includes the method of example 13, and/or some other example herein, wherein the second WebRTC server is deployed in a same mobile network operator (MNO) than the UE.

Example 18 includes the method of example 13, and/or some other example herein, wherein the second WebRTC server is deployed in a different mobile network operator (MNO) than the UE.

Example 19 includes the method of any of examples 12-18, and/or some other example herein, wherein the first communication interface is an RTC-1 interface.

Example 20 includes the method of any of examples 12-19, and/or some other example herein, wherein the WebRTC signaling server is deployed in a same mobile network operator (MNO) than the UE.

Example 21 includes the method of any of examples 12-20, and/or some other example herein, wherein the WebRTC signaling server is deployed in a different mobile network operator (MNO) than the UE.

Example Z01 may include an apparatus comprising means to perform one or more elements of a method described in or related to any of examples 1-21, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example Z03 may include an apparatus comprising logic, modules, or circuitry to perform one or more elements of a method described in or related to any of examples 1-21, or any other method or process described herein.

Example Z04 may include a method, technique, or process as described in or related to any of examples 1-21, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example Z06 may include a signal as described in or related to any of examples 1-21, or portions or parts thereof.

Example Z07 may include a datagram, packet, frame, segment, protocol data unit (PDU), or message as described in or related to any of examples 1-21, or portions or parts thereof, or otherwise described in the present disclosure.

Example Z08 may include a signal encoded with data as described in or related to any of examples 1-21, or portions or parts thereof, or otherwise described in the present disclosure.

Example Z09 may include a signal encoded with a datagram, packet, frame, segment, protocol data unit (PDU), or message as described in or related to any of examples 1-21, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example Z11 may include a computer program comprising instructions, wherein execution of the program by a processing element is to cause the processing element to carry out the method, techniques, or process as described in or related to any of examples 1-21, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 3GPP Third Generation | Retention Priority | CA Carrier Aggregation, |
| Partnership Project | ARQ Automatic Repeat | Certification |
| 4G Fourth Generation | Request | Authority |
| 5G Fifth Generation | AS Access Stratum | CAPEX CAPital |
| 5GC 5G Core network | ASP Application | Expenditure |
| AC Application | Service Provider | CBD Candidate Beam |
| Client | | Detection |
| ACR Application Context | ASN.1 Abstract Syntax | CBRA Contention Based |
| Relocation | Notation One | Random Access |
| ACK Acknowledgement | AUSF Authentication | CC Component Carrier, |
| ACID Application | Server Function | Country Code, |
| Client Identification | AWGN Additive | Cryptographic |
| AF Application | White Gaussian Noise | Checksum |
| Function | BAP Backhaul | CCA Clear Channel |
| AM Acknowledged | Adaptation Protocol | Assessment |
| Mode | BCH Broadcast Channel | CCE Control Channel |
| AMBR Aggregate | BER Bit Error Ratio | Element |
| Maximum Bit Rate | BFD Beam Failure | CCCH Common Control |
| AMF Access and Mobility | Detection | Channel |
| Management | BLER Block Error Rate | CE Coverage |
| Function | BPSK Binary Phase Shift | Enhancement |
| AN Access Network | Keying | CDM Content Delivery |
| ANR Automatic | BRAS Broadband Remote | Network |
| Neighbour Relation | Access Server | CDMA Code- |
| AOA Angle of | BSS Business Support | Division Multiple |
| Arrival | System | Access |
| AP Application | BS Base Station | CDR Charging Data |
| Protocol, Antenna | BSR Buffer Status Report | Request |
| Port, Access Point | BW Bandwidth | CDR Charging Data |
| API Application | BWP Bandwidth Part | Response |
| Programming Interface | C-RNTI Cell Radio | CFRA Contention Free |
| APN Access Point Name | Network Temporary | Random Access |
| ARP Allocation and | Identity | CG Cell Group |
| CGF Charging | CPE Customer Premise | CSI-RS CSI |
| Gateway Function | Equipment | Reference Signal |
| CHF Charging | CPICHCommon Pilot | CSI-RSRP CSI |
| Function | Channel | reference signal |
| CI Cell Identity | CQI Channel Quality | received power |
| CID Cell-ID (e.g., | Indicator | CSI-RSRQ CSI |
| positioning method) | CPU CSI processing unit, | reference signal |
| CIM Common | Central Processing | received quality |
| Information Model | Unit | CSI-SINR CSI signal- |
| CIR Carrier to | C/R Command/Response | to-noise and interference |
| Interference Ratio | field bit | ratio |
| CK Cipher Key | CRAN Cloud Radio Access | CSMA Carrier Sense |
| CM Connection | Network, Cloud | Multiple Access |
| Management, Conditional | RAN | CSMA/CA CSMA with |
| Mandatory | CRB Common Resource | collision avoidance |
| CMAS Commercial Mobile | Block | CSS Common Search |
| Alert Service | CRC Cyclic Redundancy | Space, Cell- specific |
| CMD Command | Check | Search Space |
| CMS Cloud Management | CRI Channel-State | CTF Charging |
| System | Information Resource | Trigger Function |
| CO Conditional | Indicator, CSI-RS | CTS Clear-to-Send |
| Optional | Resource Indicator | CW Codeword |
| COMP Coordinated Multi- | C-RNTI Cell RNTI | CWS Contention Window |
| Point | CS Circuit Switched | Size |
| CORESET Control | CSCF call session | D2D Device-to-Device |
| Resource Set | control function | DC Dual Connectivity, |
| COTS Commercial Off- | CSAR Cloud Service | Direct Current |
| The-Shelf | Archive | DCI Downlink Control |
| CP Control Plane, | CSI Channel-State | Information |
| Cyclic Prefix, Connection | Information | DF Deployment Flavour |
| Point | CSI-IM CSI | DL Downlink |
| CPD Connection Point | Interference | DMTF Distributed |
| Descriptor | Measurement | Management Task Force |
| DPDK Data Plane | Enhanced CCE | GPRS |
| Development Kit | ED Energy Detection | EIR Equipment Identity |
| DM-RS, DMRS | EDGE Enhanced Datarates | Register |
| Demodulation | for GSM Evolution | eLAA enhanced Licensed |
| Reference Signal | (GSM Evolution) | Assisted Access, |
| DN Data network | EAS Edge | enhanced LAA |
| DNN Data Network | Application Server | EM Element Manager |
| Name | EASID Edge | eMBB Enhanced Mobile |
| DNAI Data Network | Application Server | Broadband |
| Access Identifier | Identification | EMS Element |
| | ECS Edge | Management System |
| DRB Data Radio Bearer | Configuration Server | eNB evolved NodeB, E- |
| DRS Discovery | ECSP Edge | UTRAN Node B |
| Reference Signal | Computing Service | EN-DC E-UTRA-NR |
| DRX Discontinuous | Provider | Dual Connectivity |
| Reception | EDN Edge Data | EPC Evolved Packet |
| DSL Domain Specific | Network | Core |
| Language. Digital | EEC Edge | EPDCCH enhanced |
| Subscriber Line | Enabler Client | PDCCH, enhanced |
| DSLAM DSL Access | EECID Edge | Physical Downlink |
| Multiplexer | Enabler Client | Control Cannel |
| DwPTS Downlink | Identification | EPRE Energy per resource |
| Pilot Time Slot | EES Edge | element |
| E-LAN Ethernet | Enabler Server | EPS Evolved Packet |
| Local Area Network | EESID Edge | System |
| E2E End-to-End | Enabler Server | EREG enhanced REG, |
| EAS Edge Application | Identification | enhanced resource |
| Server | EHE Edge | element groups |
| ECCA extended clear | Hosting Environment | ETSI European |
| channel assessment, | EGMF Exposure | Telecommunications |
| extended CCA | Governance Management | Standards Institute |
| ECCE Enhanced Control | Function | ETWS Earthquake and |
| Channel Element, | EGPRS Enhanced | Tsunami Warning |
| System | Commission | GLONASS GLObal'naya |
| eUICC embedded UICC, | FCCH Frequency | NAvigatsionnaya |
| embedded Universal | Correction CHannel | Sputnikovaya |
| Integrated Circuit Card | FDD Frequency Division | Sistema (Engl .: |
| E-UTRA Evolved | Duplex | Global Navigation |
| UTRA | FDM Frequency Division | Satellite System) |
| E-UTRAN Evolved | Multiplex | gNB Next Generation |
| UTRAN | FDMA Frequency Division | NodeB |
| EV2X Enhanced V2X | Multiple Access | gNB-CU gNB- |
| F1AP F1 Application | FE Front End | centralized unit, Next |
| Protocol | FEC Forward Error | Generation NodeB |
| F1-C F1 Control plane | Correction | centralized unit |
| interface | FFS For Further Study | gNB-DU gNB- |
| F1-U F1 User plane | FFT Fast Fourier | distributed unit, Next |
| interface | Transformation | Generation NodeB |
| FACCH Fast | feLAA further enhanced | distributed unit |
| Associated Control | Licensed Assisted | GNSS Global Navigation |
| CHannel | Access, further | Satellite System |
| FACCH/F Fast | enhanced LAA | GPRS General Packet |
| Associated Control | FN Frame Number | Radio Service |
| Channel/Full rate | FPGA Field-Programmable | GPSI Generic |
| FACCH/H Fast | Gate Array | Public Subscription |
| Associated Control | FR Frequency Range | Identifier |
| Channel/Half rate | FQDN Fully Qualified | GSM Global System for |
| FACH Forward Access | Domain Name | Mobile |
| Channel | G-RNTI GERAN | Communications, |
| FAUSCH Fast Uplink | Radio Network | Groupe Spécial |
| Signalling Channel | Temporary Identity | Mobile |
| FB Functional Block | GERAN GSM EDGE | GTP GPRS Tunneling |
| FBI Feedback | RAN, GSM EDGE Radio | Protocol |
| Information | Access Network | GTP-UGPRS Tunnelling |
| FCC Federal | GGSN Gateway GPRS | Protocol for User |
| Communications | Support Node | Plane |
| GTS Go To Sleep Signal | Transfer Protocol | Intermodulation, IP |
| (related to WUS) | Secure (https is | Multimedia |
| GUMMEI Globally | http/1.1 over SSL, | IMC IMS Credentials |
| Unique MME Identifier | i.e. port 443) | IMEI International Mobile |
| GUTI Globally Unique | I-Block Information | Equipment Identity |
| Temporary UE Identity | Block | IMGI International mobile |
| HARQ Hybrid ARQ, | ICCID Integrated Circuit | group identity |
| Hybrid Automatic | Card Identification | IMPI IP Multimedia |
| Repeat Request | IAB Integrated Access | Private Identity |
| HANDO Handover | and Backhaul | IMPU IP Multimedia |
| HFN HyperFrame | ICIC Inter-Cell | PUblic identity |
| Number | Interference Coordination | IMS IP Multimedia |
| HHO Hard Handover | ID Identity, identifier | Subsystem |
| HLR Home Location | IDFT Inverse Discrete | IMSI International Mobile |
| Register | Fourier Transform | Subscriber Identity |
| HN Home Network | IE Information element | IoT Internet of Things |
| HO Handover | IBE In-Band Emission | IP Internet Protocol |
| HPLMN Home Public | | Ipsec IP Security, Internet |
| Land Mobile Network | IEEE Institute of | Protocol Security |
| HSDPA High Speed | Electrical and Electronics | IP-CAN IP- |
| Downlink Packet | Engineers | Connectivity Access |
| Access | IEI Information Element | Network |
| HSN Hopping Sequence | Identifier | IP-M IP Multicast |
| Number | IEIDL Information Element | IPv4 Internet Protocol |
| HSPA High Speed Packet | Identifier Data | Version 4 |
| Access | Length | IPv6 Internet Protocol |
| HSS Home Subscriber | IETF Internet Engineering | Version 6 |
| Server | Task Force | IR Infrared |
| HSUPA High Speed | IF Infrastructure | IS In Sync |
| Uplink Packet Access | IIOT Industrial Internet of | IRP Integration |
| HTTP Hyper Text Transfer | Things | Reference Point |
| Protocol | IM Interference | ISDN Integrated Services |
| HTTPS Hyper Text | Measurement, | Digital Network |
| ISIM IM Services Identity | reference signal | LWIP LTE/WLAN Radio |
| Module | received power | Level Integration with |
| ISO International | L2 Layer 2 (data link | IPsec Tunnel |
| Organisation for | layer) | LTE Long Term |
| Standardisation | L3 Layer 3 (network | Evolution |
| ISP Internet Service | layer) | M2M Machine-to- |
| Provider | LAA Licensed Assisted | Machine |
| IWF Interworking- | Access | MAC Medium Access |
| Function | LAN Local Area Network | Control (protocol |
| I-WLAN Interworking | LADN Local Area | layering context) |
| WLAN | Data Network | MAC Message |
| Constraint length of | LBT Listen Before Talk | authentication code |
| the convolutional code, | LCM LifeCycle | (security/encryption |
| USIM Individual key | Management | context) |
| kB Kilobyte (1000 | LCR Low Chip Rate | MAC-A MAC used |
| bytes) | LCS Location Services | for authentication and |
| kbps kilo-bits per second | LCID Logical | key agreement (TSG T |
| Kc Ciphering key | Channel ID | WG3 context) |
| Ki Individual | LI Layer Indicator | MAC-IMAC used for data |
| subscriber | LLC Logical Link | integrity of signalling |
| authentication key | Control, Low Layer | messages (TSG T |
| KPI Key Performance | Compatibility | WG3 context) |
| Indicator | LMF Location | MANO Management |
| KQI Key Quality | Management Function | and Orchestration |
| Indicator | LOS Line of Sight | MBMS Multimedia |
| KSI Key Set Identifier | LPLMN Local PLMN | Broadcast and Multicast |
| ksps kilo-symbols per | LPP LTE Positioning | Service |
| second | Protocol | MBSFN Multimedia |
| KVM Kernel Virtual | LSB Least Significant Bit | Broadcast multicast |
| Machine | LTE Long Term | service Single Frequency |
| L1 Layer 1 (physical | Evolution | Network |
| layer) | LWA LTE-WLAN | MCC Mobile Country |
| L1-RSRP Layer 1 | aggregation | Code |
| MCG Master Cell Group | Object, Mobile | Subscriber ISDN |
| MCOT Maximum Channel | Originated | Number |
| Occupancy Time | MPBCH MTC | MT Mobile Terminated, |
| MCS Modulation and | Physical Broadcast | Mobile Termination |
| coding scheme | CHannel | MTC Machine-Type |
| MDAFManagement Data | MPDCCH MTC | Communications |
| Analytics Function | Physical Downlink | mMTCmassive MTC, |
| MDAS Management Data | Control CHannel | massive Machine- |
| Analytics Service | MPDSCH MTC | Type Communications |
| MDT Minimization of | Physical Downlink | MU-MIMO Multi User |
| Drive Tests | Shared CHannel | MIMO |
| ME Mobile Equipment | MPRACH MTC | MWUS MTC wake- |
| MeNB master eNB | Physical Random | up signal, MTC WUS |
| MER Message Error Ratio | Access CHannel | NACK Negative |
| MGL Measurement Gap | MPUSCH MTC | Acknowledgement |
| Length | Physical Uplink Shared | NAI Network Access |
| MGRP Measurement Gap | Channel | Identifier |
| Repetition Period | MPLS MultiProtocol Label | NAS Non-Access |
| MIB Master Information | Switching | Stratum, Non- Access |
| Block, Management | MS Mobile Station | Stratum layer |
| Information Base | MSB Most Significant Bit | NCT Network |
| MIMO Multiple Input | MSC Mobile Switching | Connectivity Topology |
| Multiple Output | Centre | NC-JT Non- |
| MLC Mobile Location | MSI Minimum System | Coherent Joint |
| Centre | Information, MCH | Transmission |
| MM Mobility | Scheduling | NEC Network Capability |
| Management | Information | Exposure |
| MME Mobility | MSID Mobile Station | NE-DC NR-E-UTRA |
| Management Entity | Identifier | Dual Connectivity |
| MN Master Node | MSIN Mobile Station | NEF Network Exposure |
| MNO Mobile | Identification | Function |
| Network Operator | Number | NF Network Function |
| MO Measurement | MSISDN Mobile | NFP Network |
| Forwarding Path | Physical Uplink | WUS |
| NFPD Network | Shared CHannel | NZP Non-Zero Power |
| Forwarding Path | NPSS Narrowband | O&M Operation and |
| Descriptor | Primary | Maintenance |
| NFV Network Functions | Synchronization | ODU2 Optical channel |
| Virtualization | Signal | Data Unit - type 2 |
| NFVI NFV Infrastructure | NSSS Narrowband | OFDM Orthogonal |
| NFVO NFV Orchestrator | Secondary | Frequency Division |
| NG Next Generation, | Synchronization | Multiplexing |
| Next Gen | Signal | OFDMA Orthogonal |
| NGEN-DC NG-RAN E- | NR New Radio, | Frequency Division |
| UTRA-NR Dual | Neighbour Relation | Multiple Access |
| Connectivity | NRF NF Repository | OOB Out-of-band |
| NM Network Manager | Function | OOS Out of Sync |
| NMS Network | NRS Narrowband | OPEX OPerating EXpense |
| Management System | Reference Signal | OSI Other System |
| N-POP Network Point of | NS Network Service | Information |
| Presence | NSA Non-Standalone | OSS Operations Support |
| NMIB, N-MIB Narrowband | operation mode | System |
| MIB | NSD Network Service | OTA over-the-air |
| NPBCNarrowband | Descriptor | PAPR Peak-to-Average |
| Physical Broadcast | NSR Network Service | Power Ratio |
| CHannel | Record | PAR Peak to Average |
| NPDCCH Narrowband | NSSAINetwork Slice | Ratio |
| Physical Downlink | Selection Assistance | PBCH Physical Broadcast |
| Control CHannel | Information | Channel |
| NPDSCH Narrowband | S-NNSAI Single- | PC Power Control, |
| Physical Downlink | NSSAI | Personal Computer |
| Shared CHannel | NSSF Network Slice | PCC Primary Component |
| NPRACH Narrowband | Selection Function | Carrier, Primary CC |
| Physical Random | NW Network | P-CSCF Proxy CSCF |
| Access CHannel | NWUS Narrowband wake- | PCell Primary Cell |
| NPUSCH Narrowband | up signal, Narrowband | PCI Physical Cell ID, |
| Physical Cell Identity | PHY Physical layer | PS Packet Services |
| PCEF Policy and Charging | PLMN Public Land Mobile | PSBCH Physical |
| Enforcement | Network | Sidelink Broadcast |
| Function | PIN Personal | Channel |
| PCF Policy Control | Identification Number | PSDCH Physical |
| Function | PM Performance | Sidelink Downlink |
| PCRF Policy Control and | Measurement | Channel |
| Charging Rules | PMI Precoding Matrix | PSCCH Physical |
| Function | Indicator | Sidelink Control |
| PDCP Packet Data | PNF Physical Network | Channel |
| Convergence Protocol, | Function | PSSCH Physical |
| Packet Data Convergence | PNFD Physical Network | Sidelink Shared |
| Protocol layer | Function Descriptor | Channel |
| PDCCH Physical | PNFR Physical Network | PSFCH physical |
| Downlink Control | Function Record | sidelink feedback |
| Channel | POC PTT over Cellular | channel |
| PDCP Packet Data | PP, PTP Point-to- | PSCell Primary SCell |
| Convergence Protocol | Point | PSS Primary |
| PDN Packet Data | PPP Point-to-Point | Synchronization |
| Network, Public Data | Protocol | Signal |
| Network | PRACH Physical | PSTN Public Switched |
| PDSCH Physical | RACH | Telephone Network |
| Downlink Shared | PRB Physical resource | PT-RS Phase-tracking |
| Channel | block | reference signal |
| PDU Protocol Data Unit | PRG Physical resource | PTT Push-to-Talk |
| PEI Permanent | block group | PUCCH Physical |
| Equipment Identifiers | ProSe Proximity Services, | Uplink Control |
| PFD Packet Flow | Proximity-Based | Channel |
| Description | Service | PUSCH Physical |
| P-GW PDN Gateway | PRS Positioning | Uplink Shared |
| PHICH Physical | Reference Signal | Channel |
| hybrid-ARQ indicator | PRR Packet Reception | QAM Quadrature |
| channel | Radio | Amplitude Modulation |
| QCI QoS class of | Radio Bearer | RNL Radio Network |
| identifier | RBG Resource block | Layer |
| QCL Quasi co-location | group | RNTI Radio Network |
| QFI QoS Flow ID, QoS | REG Resource Element | Temporary Identifier |
| Flow Identifier | Group | ROHC RObust Header |
| QoS Quality of Service | Rel Release | Compression |
| QPSK Quadrature | REQ REQuest | RRC Radio Resource |
| (Quaternary) Phase Shift | RF Radio Frequency | Control, Radio |
| Keying | RI Rank Indicator | Resource Control layer |
| QZSS Quasi-Zenith | RIV Resource indicator | RRM Radio Resource |
| Satellite System | value | Management |
| RA-RNTI Random | RL Radio Link | RS Reference Signal |
| Access RNTI | RLC Radio Link Control, | RSRP Reference Signal |
| RAB Radio Access | Radio Link Control layer | Received Power |
| Bearer, Random | RLC AM RLC | RSRQ Reference Signal |
| Access Burst | Acknowledged Mode | Received Quality |
| RACH Random Access | RLC UM RLC | RSSI Received Signal |
| Channel | Unacknowledged Mode | Strength Indicator |
| RADIUS Remote | RLF Radio Link Failure | RSU Road Side Unit |
| Authentication Dial In | RLM Radio Link | RSTD Reference Signal |
| User Service | Monitoring | Time difference |
| RAN Radio Access | RLM-RS Reference | RTP Real Time Protocol |
| Network | Signal for RLM | RTS Ready-To-Send |
| RAND RANDom number | RM Registration | RTT Round Trip Time |
| (used for | Management | Rx Reception, |
| authentication) | RMC Reference | Receiving, Receiver |
| RAR Random Access | Measurement Channel | S1AP S1 Application |
| Response | RMSI Remaining MSI, | Protocol |
| RAT Radio Access | Remaining Minimum | S1-MME S1 for the |
| Technology | System Information | control plane |
| RAU Routing Area | RN Relay Node | S1-U S1 for the user plane |
| Update | RNC Radio Network | S-CSCF serving |
| RB Resource block, | Controller | CSCF |
| S-GW Serving Gateway | SCTP Stream Control | Support Node |
| S-RNTI SRNC Radio | Transmission | S-GW Serving Gateway |
| Network Temporary | Protocol | SI System Information |
| Identity | SDAP Service Data | SI-RNTI System |
| S-TMSI SAE | Adaptation Protocol, | Information RNTI |
| Temporary Mobile | Service Data Adaptation | SIB System Information |
| Station Identifier | Protocol layer | Block |
| SA Standalone | SDL Supplementary | SIM Subscriber Identity |
| operation mode | Downlink | Module |
| SAE System Architecture | SDNF Structured Data | SIP Session Initiated |
| Evolution | Storage Network | Protocol |
| SAP Service Access | Function | SiP System in Package |
| Point | SDP Session Description | SL Sidelink |
| SAPD Service Access | Protocol | SLA Service Level |
| Point Descriptor | SDSF Structured Data | Agreement |
| SAPI Service Access | Storage Function | SM Session |
| Point Identifier | SDT Small Data | Management |
| SCC Secondary | Transmission | SMF Session |
| Component Carrier, | SDU Service Data Unit | Management Function |
| Secondary CC | SEAF Security Anchor | SMS Short Message |
| SCell Secondary Cell | Function | Service |
| SCEF Service | SeNB secondary eNB | SMSF SMS Function |
| Capability Exposure | SEPP Security Edge | SMTC SSB-based |
| Function | Protection Proxy | Measurement Timing |
| SC-FDMA Single | SFI Slot format | Configuration |
| Carrier Frequency | indication | SN Secondary Node, |
| Division Multiple | SFTD Space-Frequency | Sequence Number |
| Access | Time Diversity, SFN and | SoC System on Chip |
| SCG Secondary Cell | frame timing difference | SON Self-Organizing |
| Group | SFN System Frame | Network |
| SCM Security Context | Number | SpCell Special Cell |
| Management | SgNB Secondary gNB | SP-CSI-RNTISemi- |
| SCS Subcarrier Spacing | SGSN Serving GPRS | Persistent CSI RNTI |
| SPS Semi-Persistent | Synchronization | Protocol |
| Scheduling | Signal based Signal to | TDD Time Division |
| SQN Sequence number | Noise and Interference | Duplex |
| SR Scheduling Request | Ratio | TDM Time Division |
| SRB Signalling Radio | SSS Secondary | Multiplexing |
| Bearer | Synchronization | TDMA Time Division |
| SRS Sounding Reference | Signal | Multiple Access |
| Signal | SSSG Search Space Set | TE Terminal Equipment |
| SS Synchronization | Group | TEID Tunnel End Point |
| Signal | SSSIF Search Space Set | Identifier |
| SSB Synchronization | Indicator | TFT Traffic Flow |
| Signal Block | SST Slice/Service Types | Template |
| SSID Service Set | SU-MIMO Single User | TMSI Temporary Mobile |
| Identifier | MIMO | Subscriber Identity |
| SS/PBCH Block | SUL Supplementary | TNL Transport Network |
| SSBRI SS/PBCH Block | Uplink | Layer |
| Resource Indicator, | TA Timing Advance, | TPC Transmit Power |
| Synchronization | Tracking Area | Control |
| Signal Block | TAC Tracking Area Code | TPMI Transmitted |
| Resource Indicator | TAG Timing Advance | Precoding Matrix |
| SSC Session and Service | Group | Indicator |
| Continuity | TAI Tracking | TR Technical Report |
| SS-RSRP | Area Identity | TRP, TRxP Transmission |
| Synchronization | TAU Tracking Area | Reception Point |
| Signal based Reference | Update | TRS Tracking Reference |
| Signal Received | TB Transport Block | Signal |
| Power | TBS Transport Block | TRx Transceiver |
| SS-RSRQ | Size | TS Technical |
| Synchronization | TBD To Be Defined | Specifications, |
| Signal based Reference | TCI Transmission | Technical Standard |
| Signal Received | Configuration Indicator | TTI Transmission Time |
| Quality | TCP Transmission | Interval |
| SS-SINR | Communication | Tx Transmission, |
| Transmitting, | URL Uniform Resource | VNFFG VNF |
| Transmitter | Locator | Forwarding Graph |
| U-RNTI UTRAN | URLLC Ultra- | VNFFGD VNF |
| Radio Network | Reliable and Low | Forwarding Graph |
| Temporary Identity | Latency | Descriptor |
| UART Universal | USB Universal Serial Bus | VNFM VNF Manager |
| Asynchronous | USIM Universal | VoIP Voice-over-IP, |
| Receiver and | Subscriber Identity Module | Voice-over- Internet |
| Transmitter | USS UE-specific search | Protocol |
| UCI Uplink Control | space | VPLMN Visited |
| Information | UTRA UMTS Terrestrial | Public Land Mobile |
| UE User Equipment | Radio Access | Network |
| UDM Unified Data | UTRAN Universal | VPN Virtual Private |
| Management | Terrestrial Radio | Network |
| UDP User Datagram | Access Network | VRB Virtual Resource |
| Protocol | UwPTS Uplink Pilot | Block |
| UDSF Unstructured Data | Time Slot | WiMAX Worldwide |
| Storage Network | V21 Vehicle-to- | Interoperability for |
| Function | Infrastruction | Microwave Access |
| UICC Universal Integrated | V2P Vehicle-to- | WLANWireless Local Area |
| Circuit Card | Pedestrian | Network |
| UL Uplink | V2V Vehicle-to-Vehicle | WMAN Wireless |
| UM Unacknowledged | V2X Vehicle-to- | Metropolitan Area |
| Mode | everything | Network |
| UML Unified Modelling | VIM Virtualized | WPAN Wireless Personal |
| Language | Infrastructure Manager | Area Network |
| UMTS Universal Mobile | VL Virtual Link, | X2-C X2-Control plane |
| Telecommunications | VLAN Virtual LAN, | X2-U X2-User plane |
| System | Virtual Local Area | XML extensible Markup |
| UP User Plane | Network | Language |
| UPF User Plane Function | VM Virtual Machine | XRES Expected user |
| URI Uniform Resource | VNF Virtualized Network | RESponse |
| Identifier | Function | XOR exclusive OR |
| ZC | Zadoff-Chu | ZP Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1. One or more non-transitory computer-readable media comprising instructions that, upon execution of the instructions by one or more processors, are to cause a WebRTC signaling server to:
identify, from a 5G media services (5GMS) application function (AF) via a communication interface, one or more received control plane parameters that are associated with a user equipment (UE) of a wireless cellular network; and
establish a WebRTC control plane for the UE based on the one or more control plane parameters.

2. The one or more non-transitory computer-readable media of claim 1, wherein the communication interface is a first communication interface, and wherein the instructions are further to cause the WebRTC signaling server to send or receive UE network address translation (NAT)-related information with a second WebRTC server via a second communication interface.

3. The one or more non-transitory computer-readable media of claim 2, wherein the second communication interface is a RTC-2 interface.

4. The one or more non-transitory computer-readable media of claim 2, wherein the second WebRTC server is a Session Traversal Utilities for NAT (STUN) server.

5. The one or more non-transitory computer-readable media of claim 2, wherein the second WebRTC server is a Traversal Using Relays around NAT (TURN) server.

6. The one or more non-transitory computer-readable media of claim 2, wherein the second WebRTC server is deployed in a same mobile network operator (MNO) than the UE.

7. The one or more non-transitory computer-readable media of claim 2, wherein the second WebRTC server is deployed in a different mobile network operator (MNO) than the UE.

8. The one or more non-transitory computer-readable media of claim 1, wherein the first communication interface is an RTC-1 interface.

9. The one or more non-transitory computer-readable media of claim 1, wherein the WebRTC signaling server is deployed in a same mobile network operator (MNO) than the UE.

10. The one or more non-transitory computer-readable media of claim 1, wherein the WebRTC signaling server is deployed in a different mobile network operator (MNO) than the UE.

11. An electronic device comprising:
one or more processors; and
one or more non-transitory computer-readable media comprising instructions that, upon execution of the instructions by the one or more processors, are to cause a WebRTC signaling server to:
identify, from a 5G media services (5GMS) application function (AF) via a communication interface, one or more received control plane parameters that are associated with a user equipment (UE) of a wireless cellular network; and
establish a WebRTC control plane for the UE based on the one or more control plane parameters.

12. The electronic device of claim 11, wherein the communication interface is a first communication interface, and wherein the instructions are further to cause the WebRTC signaling server to send or receive UE network address translation (NAT)-related information with a second WebRTC server via a second communication interface.

13. The electronic device of claim 12, wherein the second communication interface is a RTC-2 interface.

14. The electronic device of claim 12, wherein the second WebRTC server is a Session Traversal Utilities for NAT (STUN) server.

15. The electronic device of claim 12, wherein the second WebRTC server is a Traversal Using Relays around NAT (TURN) server.

16. The electronic device of claim 12, wherein the second WebRTC server is deployed in a same mobile network operator (MNO) than the UE.

17. The electronic device of claim 12, wherein the second WebRTC server is deployed in a different mobile network operator (MNO) than the UE.

18. The electronic device of claim 11, wherein the first communication interface is an RTC-1 interface.

19. The electronic device of claim 11, wherein the WebRTC signaling server is deployed in a same mobile network operator (MNO) than the UE.

20. The electronic device of claim 11, wherein the WebRTC signaling server is deployed in a different mobile network operator (MNO) than the UE.
